(19) United States
(12) Patent Application Publication
(10) Pub. No.: US 2010/0181438 A1
(43) Pub. Date: Jul. 22, 2010

(54) CABLE ROUTING DEVICE

(76) Inventors: Frank Chauzu, Obernai (FR); Rene Chauzu, Linas (FR)

Correspondence Address: DEFILLO & ASSOCIATES, INC., P.O. Box 14104, Clearwater, FL, 33766, US

(21) Appl. No.: 12/664,896

(22) PCT Filed: Jun. 16, 2008
(86) PCT No.: PCT/FR2008/000827

§ 371 Date: Dec. 16, 2009

(30) Foreign Application Priority Data
Jun. 20, 2007 (FR) 0704390

(51) Int. Cl. F16L 3/00

(52) U.S. Cl. 248/49

(57) ABSTRACT

Device for routing cables, more particularly intended for routing and distributing electric cables having an elongated shape (1) with a U-shaped cross-section consisting of an assembly of two side posts (3) forming the arms of the U and of a base (2) forming the bottom of the U. The side posts (3) and the base (2) are substantially made from a composite material and/or a strengthened plastic material and in that at least one side post (3) is pivotally mounted while being jointed to the base (2) about an axis of rotation (30) by at least one hinge (4) and in that it comprises snap-coupling means (35,26,63,7) and abutment means (22,23,38,29,27) capable of locking the side post perpendicularly to said base (2) under the action of its rotation.

This application is a national stage entry of PCT/FR2008/000827 filed Jun. 16, 2008, under the International Convention claiming priority over French Application No. 0704390 filed Jun. 20, 2007.

### FIELD OF THE INVENTION

The object of the present invention is a device for routing cables, more particularly intended for routing and distributing electric cables.

### BACKGROUND OF THE INVENTION

Present cable routings comprise an elongated structure with a U-shaped cross-section, inside which the cables are laid and optionally attached, and either made from an assembly of metal components forming a base and side posts, commonly called <<cable ladders>>, intended to support cables with a weight of the order of 100 kg/m with supporting distances of the order of 3-4 meters, or as a one-piece structure in solid or open worked metal sheet or else further in welded wire-mesh, commonly called <<cable routes>>, intended to support cables of a weight of the order of 30 kg/m with supporting distances of the order of 1 to 2 meters.

These structures consist of several constitutive components connected end to end, generally installed horizontally and having sufficient rigidity in order to support the weight of the cables, without excessive flexure.

However, these cable routing devices occupy a significant volume during their storage and their transport up to the area of their installation, which causes high logistic costs.

In order to find a remedy to these drawbacks, wire-mesh devices for routing metal cables are known, the side posts of which devices are jointed to the base of the structure in order to be able to place the cable route in a planar or L-shaped configuration for its storing by stacking the structures over each other or in a U-shaped configuration, i.e. with posts perpendicular to the base for its installation on site.

However in order to maintain the cable route jointed in its U-shaped configuration with view to installing it on site, it is necessary to manually place or actuate right-angled or ring-shaped blocking components at each mesh of the wire mesh between the side posts and the base which makes the operation tedious and costly in assembly time.

Additionally, metal cable routing devices have a great weight and may have sharp edges, after cutting, which damage the cables or injure the installers. Moreover, they are electrically conductive, which imposes that each component of the cable routing device be connected to the ground which considerably increases the installation costs.

### SUMMARY OF THE INVENTION

The object of the present invention is to find a remedy to these drawbacks by proposing a cable routing device substantially made from synthetic materials and allowing easy and rapid transformation of the cable routing device from a planar or L-shaped configuration beneficial for its making or for its storage and its transport into a U-shaped configuration for its installation on site.

The cable routing device according to the present invention is more particularly intended for routing and distributing electric cables and has an elongated shape with a U-shaped cross-section consisting of an assembly of two side posts forming the arms of the U and of a base forming the bottom of the U and is essentially characterized in that the side posts and the base are substantially made from a composite material and/or a strengthened plastic material and in that at least one side post is pivotally mounted while being jointed to the base about an axis of rotation by at least one hinge and in that it comprises snap-coupling means and abutment means capable of locking the side post perpendicularly to said base under the action of its rotation.

According to the present invention, the cable routing device will comprise at least one blocking abutment forming an obstacle to the rotation of the pivoting side post preventing its rotation beyond an angle of 90° with the base and at least one anti-return abutment which will engage by snap-coupling and preventing the rotation of the side post upon opening.

Still according to the present invention, the blocking abutment may also be engaged by snap-coupling. In this case and in a first embodiment of the snap-coupling means, the latter consist in lugs each intended to cooperate by snap-coupling both with a blocking abutment and an anti-return abutment.

In a second embodiment of the snap-coupling means, the latter consist in notches intended to be snapped onto each other as the pivoting side post gradually rotates and blocks upon opening, i.e. towards the outside of the cable route, at each rotational index, said pivoting side post in an angular position.

In a third embodiment of the snap-coupling means, the latter consist in at least one flexible flexural tab so that during the rotation of the pivoting side post, when the latter forms an angle of about 90° with the base, said tab is subject, without breaking, to an elastic deformation and will engage by snap-coupling of its free edge against the surface of an anti-return abutment.

The tab may be positioned relatively to its free edge so as to operate in compression or in traction.

Still according to the present invention, the joint between the base and the pivoting side post may be achieved by means of a multiplicity of hinges each forming a jointing point around the axis of rotation either common or not to the assembly of said hinges.

A hinge will consist of a side extension of the base hemmed into a window made in the side post, joined together around the axis of rotation, allowing rotation of the pivoting side post.

A side extension may have a hook shape intended to be engaged onto the axis of rotation during the assembling of the cable route.

In a first embodiment of a side post, the latter will be made in a single piece by profile-shaping.

In a second embodiment of a side post, the latter will be made from an assembly of at least two rods rigidly connected to each other by connecting parts and the connecting parts may be over molded on the rods or welded around the rods.

The rods will preferably made by profile-shaping from a composite material reinforced with continuous fibers while the connecting parts will be made by molding from a plastic material either reinforced or not with discontinuous fibers.

Advantageously, one of the two rods of the pivoting side post will form the axis of rotation of the pivoting side post.

Each connecting part may include a window which will be extended with a cage in the form of an inverted U, the arms of which will be flared and will clasp the side extensions so that the phase for engaging the side extensions into the cage is accomplished with play and that the tightening between said arms and the side extensions increases as the pivoting side post gradually rotates so as to become total and without any play when the angle of the pivoting side post is close to 90° with the base corresponding to the snap-coupling angle blocking the pivoting post perpendicularly to said base.

In a first embodiment of the base, the latter is an assembly made in a single piece, either solid or open worked.

In a second embodiment of the base, the latter consists of a succession of bars perpendicular to the longitudinal axis of the cable route and the side extensions of the base are formed by the free ends of said bars.

The bars may be made in a single piece by compression- or injection-molding, or by assembling a body-forming portion and at least one added end portion forming the side extension. The bars will advantageously include orifices intended for attaching the cables.

The bars may include side stabilizers bearing upon a surface of the pivoting side post allowing the bars to be blocked perpendicularly to the longitudinal axis of the cable route and preventing any longitudinal deformation of the latter during use.

The bars may have an omega-shaped cross-section, the two side legs of which may advantageously form at the end of the bars supporting surfaces intended to come into contact with a surface of the side post.

### BRIEF DESCRIPTION OF THE DRAWINGS

The advantages and the characteristics of the present invention will become more clearly apparent from the description which follows and which relates to the appended drawings which illustrate non-limiting embodiments thereof.

FIG. 1 illustrates a perspective view of a cable route in one embodiment of the side posts by assembly according to the present invention,

FIG. 2 illustrates a perspective view of a cable route according to the present invention in the embodiment of FIG. 1 in the assembling situation,

FIG. 3 illustrates a perspective view of a bar forming the base of the cable routing according to the present invention,

FIG. 4 illustrates a cross-sectional view of a cable routing according to the present invention as illustrated in FIG. 1,

FIG. 5 illustrates a perspective view of a bar in the upside-down position of a cable route according to the present invention, provided with notches at its free hook-shaped ends,

FIG. 6 illustrates a cross-sectional view of a cable route according to the present invention provided with a bar as described in FIG. 5,

FIG. 7 illustrates a perspective view of a side post of a cable route according to the present invention in an embodiment of the side posts made in a single piece,

FIG. 8 illustrates a cross-sectional view of the cable route according to the present invention illustrated in FIG. 7,

FIG. 9 illustrates a perspective view of the cable route described in FIG. 8 in the assembling situation substantially coplanar,

FIG. 10 illustrates a perspective view of a cable route described in FIG. 7 in an alternative of one of the longitudinal edges of the side posts,

FIG. 11 illustrates a perspective view of a bar provided with a snap-coupling lug at each of its free ends.

### DETAILED DESCRIPTION OF THE INVENTION

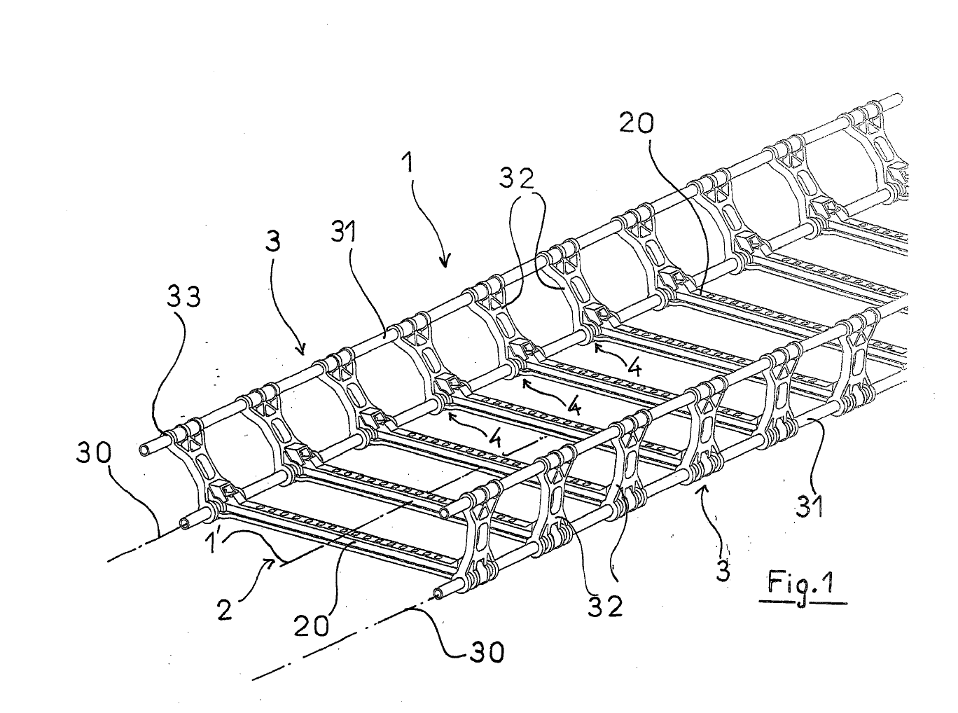

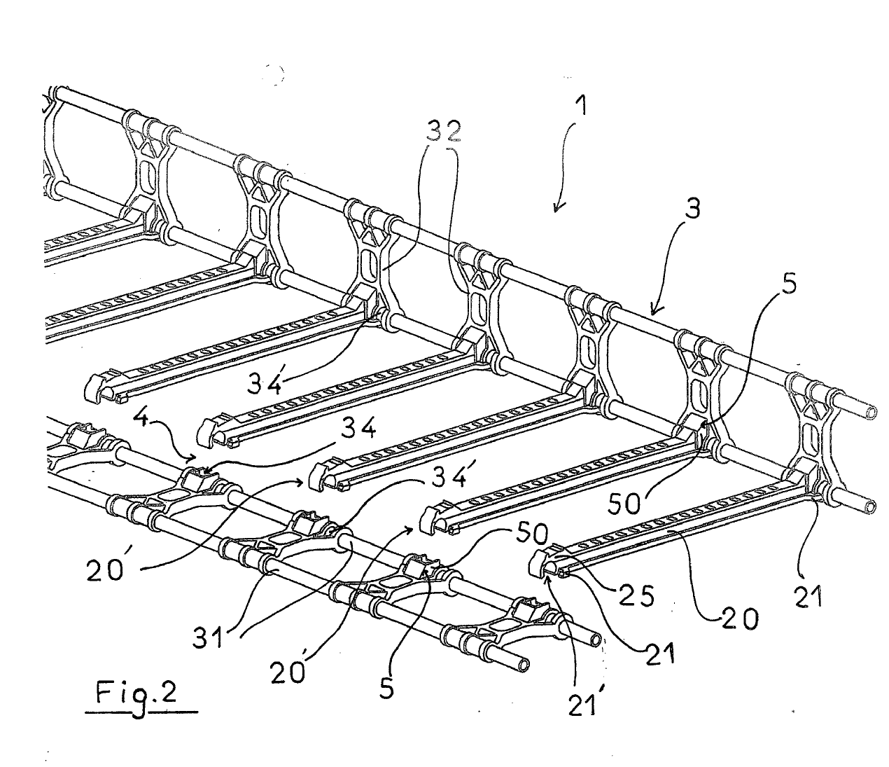

If reference is made to FIG. 1 and to FIG. 2, it may be seen that a cable routing device according to the present invention has a structure 1 with an elongated shape with a U-shaped cross-section and comprises a base 2 and two side posts 3, substantially made from a composite material or a reinforced plastic material.

The side posts 3 are pivotally mounted about an axis of rotation 30, parallel to the longitudinal axis 1′ of the cable route, defining the junction line between the base 2 and the side posts 3. In order to ensure pivoting of the side posts 3 relatively to the base 2, hinges 4 are firmly secured along the side walls of the base 2 and form a multiplicity of jointing points between the side posts 3 and the base 2.

It may be seen that the base 2 consists of a succession of bars 20, regularly spaced out, perpendicular to the longitudinal axis 1′ of the cable route 1 and to the axis of rotation 30, which bars 20 are firmly secured to the side posts 3 by their free ends 20′.

A side post 3 consists of two parallel rods 31 preferably made in a composite material and connected to each other through connecting parts 32 with a globally rectangular shape, regularly spaced out and located in the plane formed by the two straight rods 31.

A connecting part 32 is made from a reinforced plastic material and includes at each of its ends, a transverse orifice 33 intended to respectively receive the straight rods 31, one of which materializes the axis of rotation 30 of the side post 3 with the base 2.

It may also be seen that each connecting part 32 includes, at the transverse orifice intended to be crossed by the rod 31 forming the axis of rotation 30 of the side post 3, a window 34 with which the corresponding free end 20′ of a bar 20 may be hemmed into a window 34 around the rod 31 so as to ensure the joint between the base 2 and the side post 3 and to limit the possibilities of longitudinal movement of said base relative to said side post.

It will be noted that the connecting parts 32 advantageously have a recessed geometry intended for saving material while providing preferential hooking-up areas for attaching electric accessories such as distribution boxes. Moreover they have a width, in the longitudinal direction of the cable routing, sufficient for ensuring a not very deformable rigid connection between the rods 31 and which has the effect of reducing the distance between two consecutive connecting parts 32 thereby limiting the deformations undergone by the rods 31 when the cable route is under load.

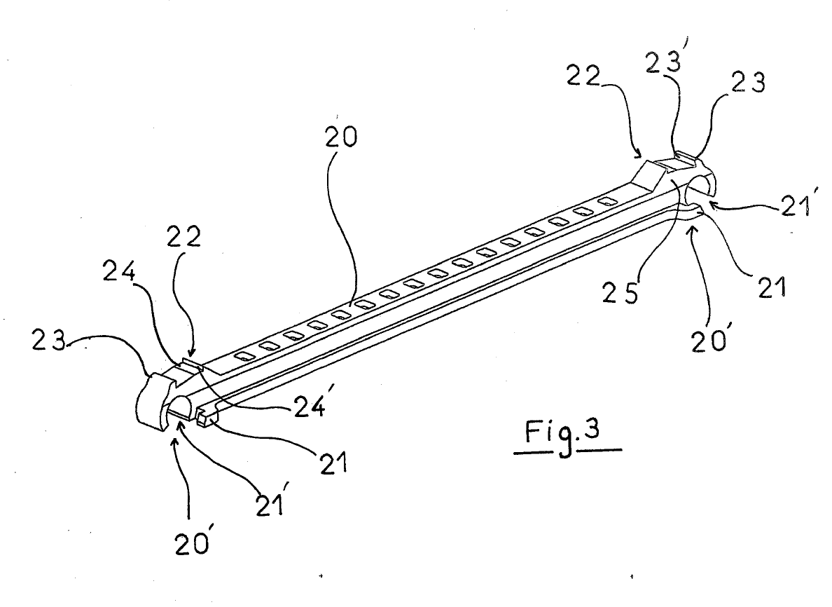

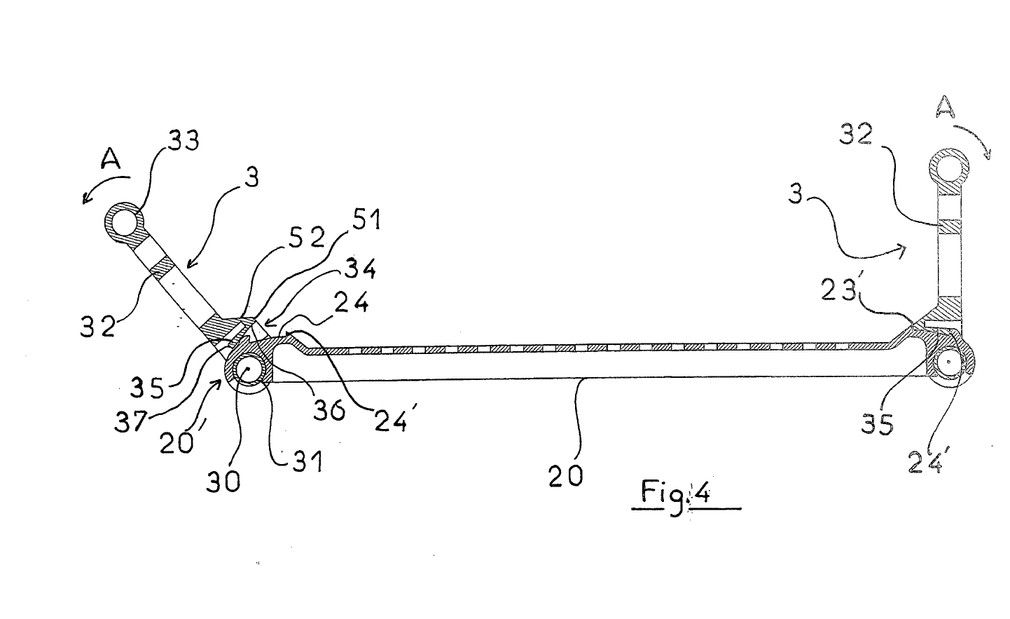

If reference is now made to FIG. 3 and FIG. 4, it may be seen that a bar 20 includes two free hook-shaped ends 20′, intended to be engaged during the assembling, as this may also be seen in FIG. 2, into the window 34 of the corresponding connecting part 32 around the axis of rotation 30 illustrated by a rod section 31 crossing the window 34 of the connecting part 32. The non-closed space 21′ of the hook 20′ will be determined so as to allow engagement on the section of the axis of rotation 30 crossing the window 34 by snap-coupling in order to reinforce securing of the bars 20 to the side posts 3 during their assembly.

An end 20′ includes two side stabilizers 21 capable of bearing against the connecting part 32 on either side of the window 34 in annular grooves 34′ preventing any side tilt of the bar 20, notably under the effect of external stresses when the electric cables are placed and drawn, which avoids any longitudinal deformation of the installed cable route 1.

It may also be seen that the upper external face of an end 20′ of a bar 20 includes two internal 22 and external 23 abutments, the external abutment 23 consisting of a vertical wall 23′ perpendicular to the longitudinal axis of the bar 20 and to the plane containing the base 2 and the internal abutment 22 consisting of a horizontal surface 24 parallel to the longitudinal axis of the bar 20 and of a vertical surface 24′ which will reinforce the abutment function of the horizontal surface 24.

The internal abutment 22 is an obstacle to rotation of the side post 3, preventing its rotation beyond an angle of 90° with the base 2 when a supporting surface 36 of the connecting parts 32 will abut against the horizontal surface 24 of the internal abutment 22.

The external abutment 23 is an anti-return abutment intended to receive by snap-coupling, when the side post 3 pivots towards the base 2 and is in an angular position of about 90° with the base 2, a supporting surface 37 of a connecting part 32 preventing rotation of the side post upon opening with the base 2, i.e. towards the outside of the cable route as indicated by A.

The supporting surface 37 is formed by the end surface of a tab 35, flexible in flexure and resistant to buckling, made in the window 34 of a connecting part 32 substantially perpendicular the plane of the connecting part 32. The tab 35 is intended to engage by snap-coupling onto the external abutment 23.

It may also be seen that a window 34 made in a connecting part 32 extends with a cage 5 in the shape of an inverted U and the arms 50 of which are flared and clasp the side walls 25, themselves also flared according to an identical tilt, from the ends 20′ of the bars 20 so that the engagement phase of the ends of the bars into the cage is accomplished with play and that tightening between said arms 50 and the side walls 25 is gradual upon rotating the side post 3, becoming total and without play when the angle of the latter is close to 90° with the base 2 upon snapping on the tab 35 thereby suppressing any side movement of the bars 20 after snap-coupling.

The tab 35 is secured at one of its ends to the front edge of the base of the U forming the roof 52 of the cage 5, the external surface of the front edge 51 forming an abutment surface intended to come into contact with the vertical surface 24′ of the internal abutment 22 of the corresponding bar 20 in order to reinforce blocking of rotation beyond an angle of 90° between the side post 3 and the base 2.

A side post 3 from a mechanical point of view, because of the properties of the different selected materials, composite and reinforced plastic material, of their geometry and positioning, thus forms a vertical flexural rigid recessed beam having a much greater inertia than the sum of the inertias of the components which make it up. However a post made in this way retains relative side flexibility allowing the cable routes to adapt by slight deformation to the installation stresses on site. Moreover with this combination of materials from different manufacturing methods, it is possible to obtain both flexible areas 35 able to deform by snap-coupling while globally retaining great rigidity of the side posts 3 because of the straight rods 30 made from a pultruded composite material and localized at the locations of the largest mechanical stresses to which the cable route is subject under load.

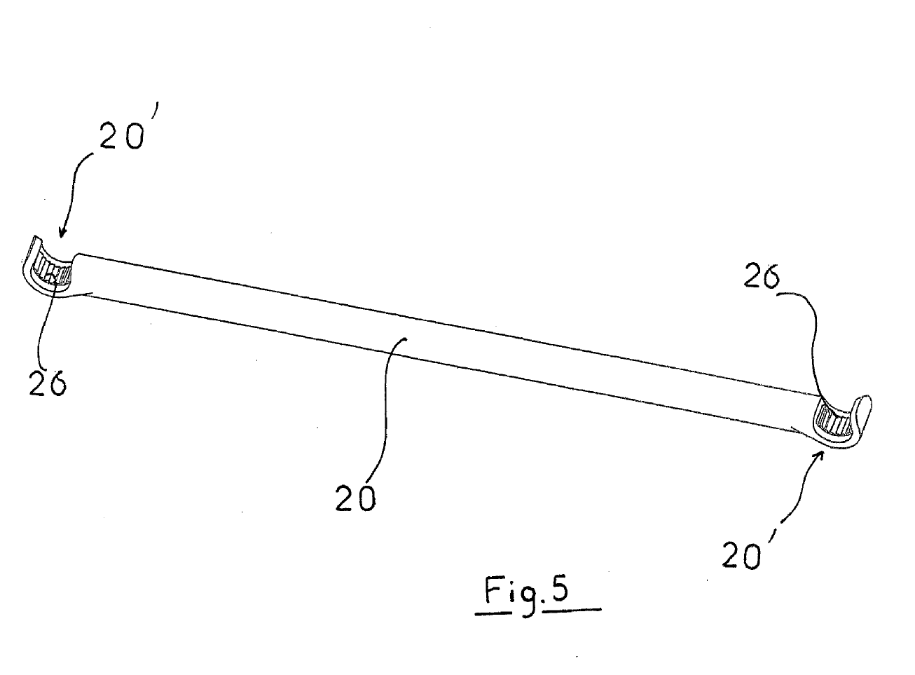

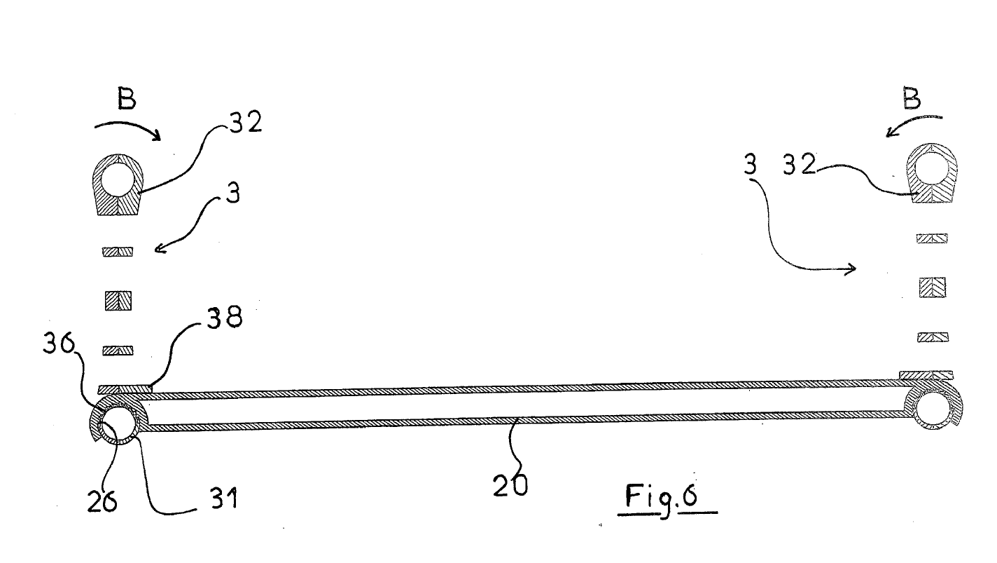

If reference is made to FIG. 5 and to FIG. 6, a bar 20 may be seen, the hook-shaped ends 20′ of which are engaged on a round rod 31 and include on their internal face a series of notches 26 intended to cooperate with mating notches 36 made on the external face of the axis of rotation 31 so as to form a circular rack, the notches 23, 36 of which will snap into each other as the side post 3 gradually rotates towards the inside of the structure 1, in the B direction, blocking at each index of rotation, said side post 3 in a given angular position until the angle between the pivoting side post 3 and the base 2 is equal to about 90°. It may also be seen that a window 34 made in a connecting part 32 includes at its upper edge a strip 38 which extends perpendicularly to the connecting part 32 and which is intended to bear against the external surface of the base 2 when the side post 3 reaches an angle of 90° with the base 2 preventing the side post 3 from pivoting beyond this angle towards the inside of the structure 1 while the notches 26, 36 prevent the side post 3 from pivoting in the opposite direction towards the outside of the structure 1.

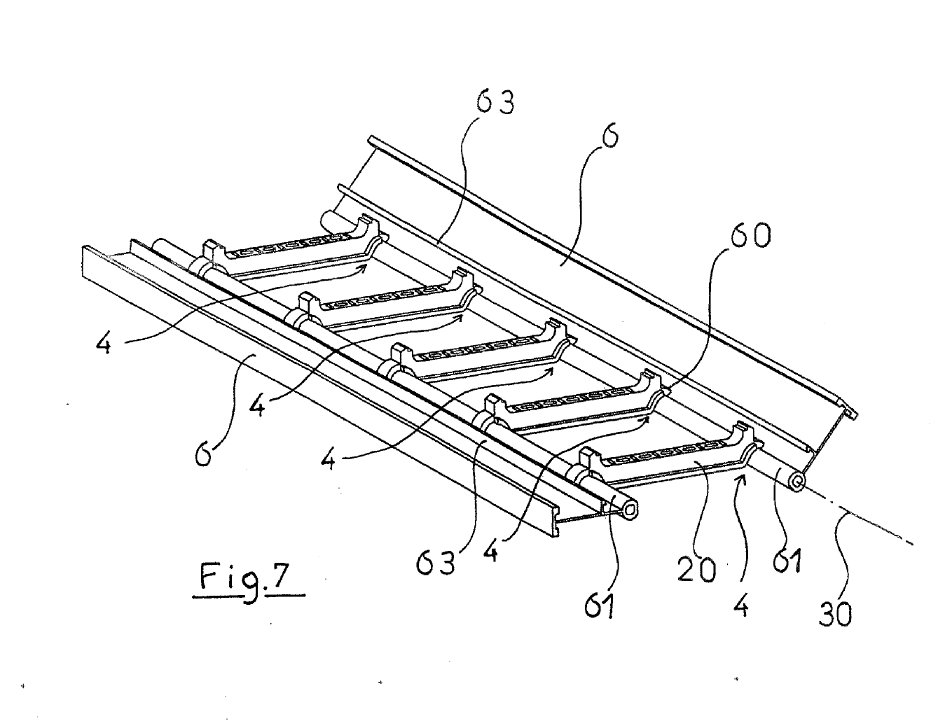

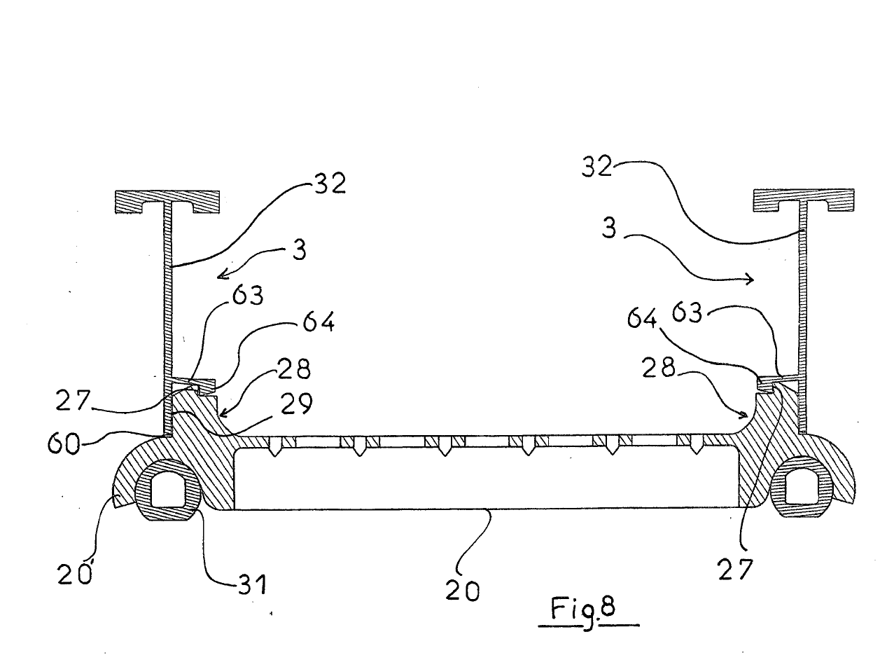

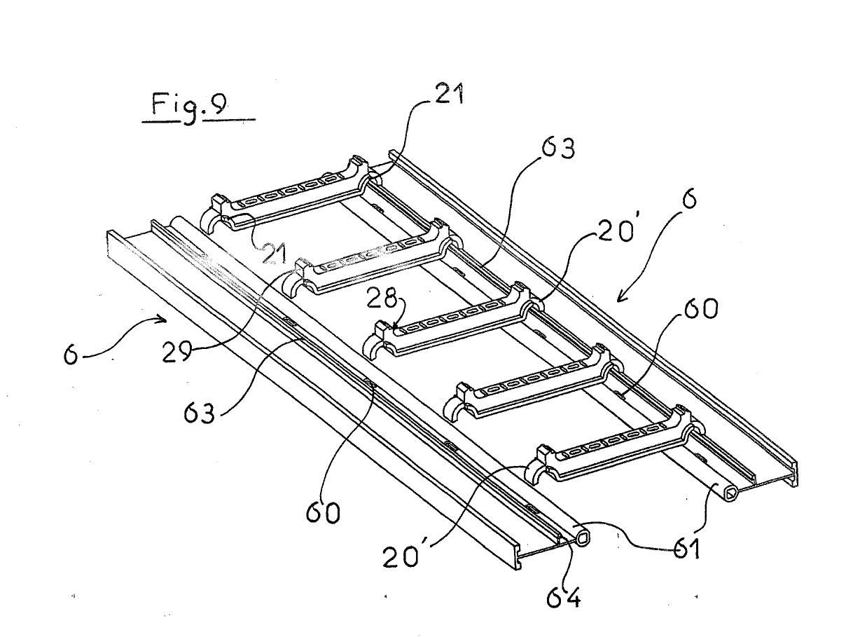

FIG. 7, FIG. 8 and FIG. 9 show a structure 1 comprising two side posts 6 made in a single piece by profile-shaping, which each appear as an elongated rectangular panel including windows 60 intended to receive the free hook-shaped ends 20′ of bars 20 forming the base 2 of the structure 1.

One 61 of the longitudinal edges of each side post 6 is rounded and forms the axis of rotation 30 about which the side post 6 pivots. The side post 61 delimits one of the sides of the windows 60, on which are engaged the free ends 20′ of the bars 20 of the base 2 hemmed into the windows 60 so as to secure the side posts 6 to the base 2, as this may be seen in FIG. 9, and to allow pivoting of the side posts 6 about the axis of rotation 30 relatively to the base 2.

Maintaining the side posts 6 in an angular position perpendicular to the base 2 is achieved by means of a tab 63 perpendicularly and longitudinally secured to the internal face of the side posts 6 which, when the side post 6 forms an angle of about 90° with the base 2, by its free longitudinal edge 64, will be snapped onto an anti-return abutment 27 made in a block 28 surmounting the external face of the free ends 20′ of the bars 20 and preventing the side post 6 from pivoting upon opening towards the outside of the structure 1.

The block 28 further includes a blocking abutment formed by a wall 29 perpendicular to the bar 20 against which the internal wall of the side post 6 will abut, when the latter forms an angle of 90° with the base 2 preventing the latter from pivoting upon closing beyond this angle towards the inside of the structure 1.

It may also be seen that the bars 20 in one of their alternative embodiments, have an omega-shaped cross-section integrating the stabilizers 21 at their free ends 20′, which stabilizers 21 have a rounded shape allowing them to fit the circular shape of the longitudinal edge 61 of a side post 6 upon which they will bear in order to reinforce the stability of the structure.

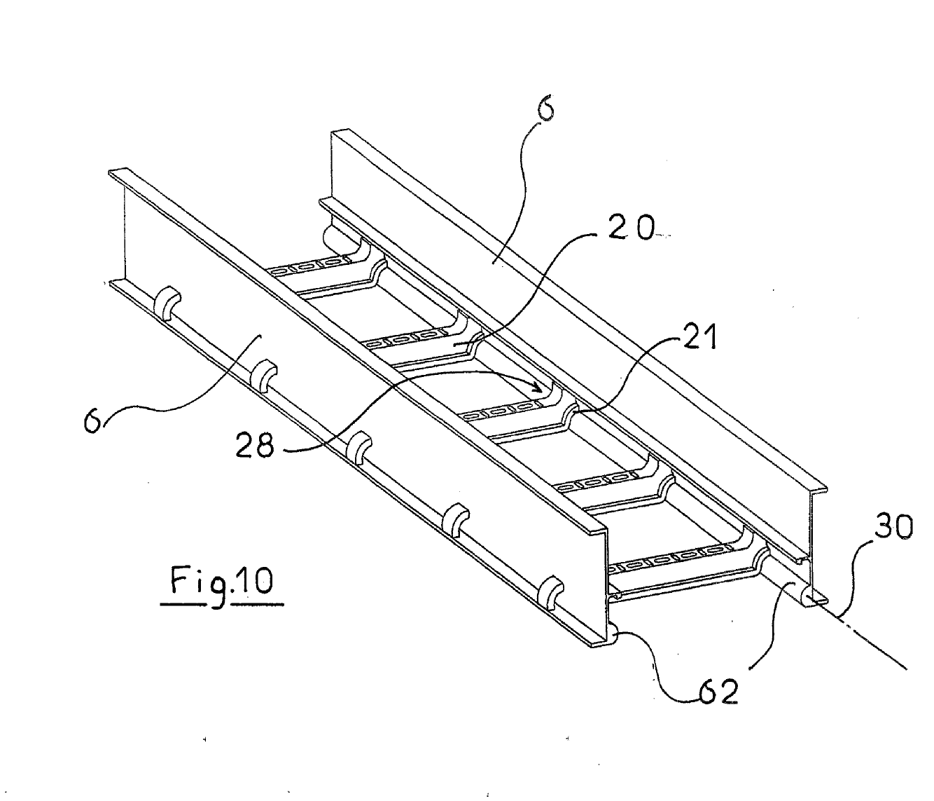

FIG. 10 shows an alternative of the side posts 6 made in a single piece, one 62 of the longitudinal edges of which forming the axis of rotation, is semi-circular inside the structure 1 of the cable route.

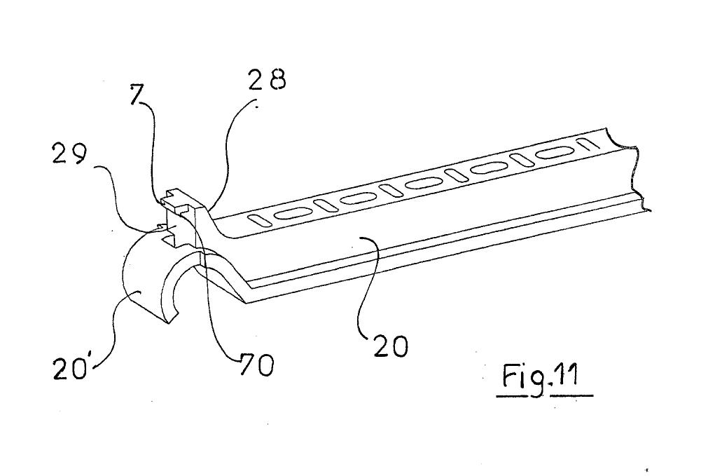

If reference is now made to FIG. 11, it may be seen that in an alternative of the side post 6 described in FIG. 7 and of the abutment and snapped-coupling means, a free end 20′ of a bar 20 is surmounted with a block 28 consisting of a wall 29 perpendicular to the bar 20 and provided with a lug 7 including at the lower face of its free end a beveled edge 70 and intended to be engaged by snap-coupling into a slot, not shown, made in the wall of the side post 6 so that the edge of the slot will be inserted between the edge 70 and the vertical wall 29 which will have the effect of blocking the side post 6 in a position perpendicular to the base.

1-22. (canceled)

23. A device for routing cables, more particularly intended for routing and distributing electric cables having an elongated shape (1) with a U-shaped cross-section comprising an assembly of two side posts (3) forming the arms of the U and of a base (2) forming the bottom of the U, substantially made from a composite material and/or a strengthened plastic material, the device comprising:
at least one side post (3) pivotally mounted while being jointed to the base (2) about an axis of rotation (30) by a multiplicity of hinges (4); and
a hinge (4) having a side extension (20′) of the base (2) forming a hook intended to be engaged around said axis of rotation (30), through a window made in the side post (3) limiting the possibilities of longitudinal movement of said base relative to said side post.

24. The device for routing cables according to claim 23, wherein said side extension comprises, at said hook, an open space positioned parallel to said base making it possible the assembling of said post and said base in a substantially coplanar arrangement.

25. The device for routing cables according to claim 23, wherein said side extension is engaged by snap-coupling on said side post for securing said side post to said base.

26. The device for routing cables according to 23, further comprising snap-coupling means (35,26,63,7) and abutment means (22,23,26,27,29,38) capable of locking said side post in a substantially perpendicular position to said base (2) under the action of its rotation.

27. The device for routing cables according to claim 26, further comprising at least one blocking abutment (22,38,29) forming an obstacle to the rotation of the pivoting side post (3) preventing its rotation beyond an angle of about 90° with the base (2) and at least one anti-return abutment (23,26,27) which will engage by snap-coupling the snap-coupling means and preventing the rotation of the side post (3) upon opening.

28. The device for routing cables according to claim 27, wherein the snap-coupling means consist in notches (26, 36) intended to be snapped onto each other as the pivoting side post (3) gradually rotates and blocks upon opening, at each rotational index, said pivoting side post (3) in an angular position.

29. The device for routing cables according to claim 27, characterized in that the snap-coupling means consist in at least one flexible flexural tab (35,63) so that during the rotation of the pivoting side post (3), when the latter forms an angle of about 90° with the base (2), said tab (35,63) is subject, without breaking, to an elastic deformation and will engage by snap-coupling of its free edge against the surface of an anti-return abutment (23,27).

30. The device for routing cables according to claim 23, wherein a side post (3) is made from an assembly of at least two rods (31) rigidly connected to each other by connecting parts (32).

31. The device for routing cables according to claim 30, wherein one of the two rods (31) of the pivoting side post (3) forms the axis of rotation (30).

32. The device for routing cables according to claim 30, wherein a connecting part (32) includes a window (34) intended to receive a side extension of the base.

33. The device for routing cables according to claim 26 wherein said window comprises an opening which allows as a first step a play when positioning said side extension of the base in a position of coplanar assembly and then performs a tightening without any play with said side extension of the base when said side post is led in a substantially perpendicular position to said base (2).

34. The device for routing cables according to claim 23, wherein the base (2) comprises a succession of bars (20) perpendicular to the longitudinal axis (1′) of the cable route (1) and the side extensions (20′) of the base (2) are formed by the free ends of said bars (20).

35. The device for routing cables according to claim 34, wherein the bars (20) are made by assembling a body-forming portion and at least one added end portion forming the side extension.

36. The device for routing cables according to 34, wherein the bars (20) include side stabilizers (21) bearing upon a surface of the pivoting side post allowing the bars (20) to be blocked perpendicularly to the longitudinal axis of the cable route and preventing any longitudinal deformation of the latter during use.
